(19) United States
(12) Patent Application Publication
(10) Pub. No.: US 2013/0040401 A1
(43) Pub. Date: Feb. 14, 2013

(54) TEST STRIP READER

(71) Applicants: Benedict L. Zin, San Diego, CA (US); Andy Sturman, San Diego, CA (US)

(72) Inventors: Benedict L. Zin, San Diego, CA (US); Andy Sturman, San Diego, CA (US)

(21) Appl. No.: 13/572,390

(22) Filed: Aug. 10, 2012

Related U.S. Application Data
(60) Provisional application No. 61/523,191, filed on Aug. 12, 2011.

(51) Int. Cl. G01N 21/01

(52) U.S. Cl. 436/164; 422/68.1

(57) ABSTRACT

In one innovative aspect, systems and methods for modular electronic test kits such that test can be more easily fabricated as well as integrated with other devices is provided. In a further innovative aspect, systems, and methods for test strip readers including improved accuracy of the tests performed by the test reader are provided.

### CROSS-REFERENCE TO RELATED APPLICATIONS

This application claims a priority benefit under 35 U.S.C. §119(e) from provisional U.S. Application No. 61/523,191 filed Aug. 12, 2011, the entirety of which is expressly incorporated herein by reference.

### BACKGROUND

1. Field

The present application relates to test reader devices and methods.

2. Background

With ever increasing health care costs, home use test kits have become a popular, low-cost alternative to expensive visits to a specialized health care provider and/or time consuming laboratory testing. Tests related to conditions such as pregnancy, fertility, and diabetes (to name only a few), may be quickly and accurately performed in home. Test readers may also be used at a point of care (e.g., lab bench readers) to provide quick results.

As a manufacturer of test readers, significant resources may be expended to produce a new reader. The housing may be designed for a particular product and/or use. The detector may be placed in a various locations depending on the test performed. The sample collector(s) may also have variable locations. Each permutation may necessitate a redesign and/or reorganization of the main processing unit included in the test reader for generating the test result. These aspects can result is increased cost for the test reader. Consumers for test readers are generally price sensitive. These aspects can result in delayed time to market while the test reader is designed. As some test readers have a low price point, competition often occurs at being the first to market with an improved design.

Accuracy of a test reader is another important characteristic for successful test readers. Consumers want test results that are highly trustworthy. Accuracy of a test may be achieved through increasing the sensitivity of the sensors. In some instances, however, this may increase the cost of the test reader. In cost sensitive market segments, this can price the reader out of the market. Accuracy of a test reader may be achieved through increasing the amount and/or type of sampling performed. In some instances, however, this may increase the burden on the consumer to provide a larger sample or more frequent samples.

### SUMMARY

The systems, methods, and devices of the disclosure each have several innovative aspects, no single one of which is solely responsible for the desirable attributes disclosed herein.

In one innovative aspect, a test reader is provided. The test reader includes an inner housing containing a display, such as a liquid crystal display, a sensor configured to generate a signal indicating a property of a test strip, and a processor configured to receive the signal from the sensor and generate a test result for presentation via the display based on the received signal. One example of the property of the test strip is an amount of light reflected by the test strip. The test reader further includes an outer housing having the inner housing contained therein. In some implementations, the test reader also includes a light source contained within the inner housing, wherein the sensor is a photodiode. In some implementations, the test strip is coupled to the inner housing.

In a further innovative aspect, a method of detecting an analyte in a sample on a test strip is provided. The method includes receiving a first plurality of values from a sensor indicating a property of the test strip. The method further includes generating a second plurality of values describing characteristics of the received values, each characteristic having a percentage membership value associated therewith. The method also includes generating a composite characteristic value based at least in part on the second plurality of values. The method also includes generating a final test result based at least in part on a comparison between the composite characteristic value and a threshold.

In another innovative aspect, another test strip reader is provided. The test reader includes means for receiving a sample including an analyte of interest. The test reader includes means for receiving a first plurality of values from a sensor indicating a property of the means for receiving the sample. The test reader further includes means for generating a second plurality of values describing characteristics of the received values, each characteristic having a percentage membership value associated therewith. The test reader also includes means for generating a composite characteristic value based at least in part on the second plurality of values. The test reader also includes means for generating a final test result based at least in part on a comparison between the composite characteristic value and a threshold.

In a further innovative aspect, a computer-readable storage medium comprising instructions executable by a processor of an apparatus including a test strip is provided. The instructions cause the apparatus to receive a first plurality of values from a sensor indicating a property of the test strip. The instructions further cause the apparatus to generate a second plurality of values describing characteristics of the received values, each characteristic having a percentage membership value associated therewith. The instructions also cause the apparatus to generate a composite characteristic value based at least in part on the second plurality of values. The instructions cause the apparatus to generating a final test result based at least in part on a comparison between the composite characteristic value and a threshold.

In yet another innovative aspect, another test reader is provided. The test reader includes an inner housing containing all the electronics for the test reader, wherein the inner housing is positioned inside an outer housing. In some implementations, a test strip is coupled to the inner housing. In some implementations, the test strip and all the electronics for the test reader are mounted to the outer housing only through an engagement between the inner housing and the outer housing.

Details of one or more implementations of the subject matter described in this specification are set forth in the accompanying drawings and the description below. Other features, aspects, and advantages will become apparent from the description, drawings, and claims. Note that the relative dimensions of the following figures may not be drawn to scale.

### BRIEF DESCRIPTION OF THE DRAWINGS

FIG. 1 illustrates a schematic of an exploded view for an example test reader.

FIG. 2 illustrates a schematic of an assembled view for an example test reader.

FIGS. 3A and 3B show schematic views of an exemplary test reader engine.

FIG. 4 shows a partially assembled view of an exemplary test reader engine with the lower housing removed.

FIG. 5 illustrates a circuit diagram for an example electronics component of a test reader engine.

FIG. 6 illustrates a process flow diagram for generating a test result.

In accordance with common practice, the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### DETAILED DESCRIPTION

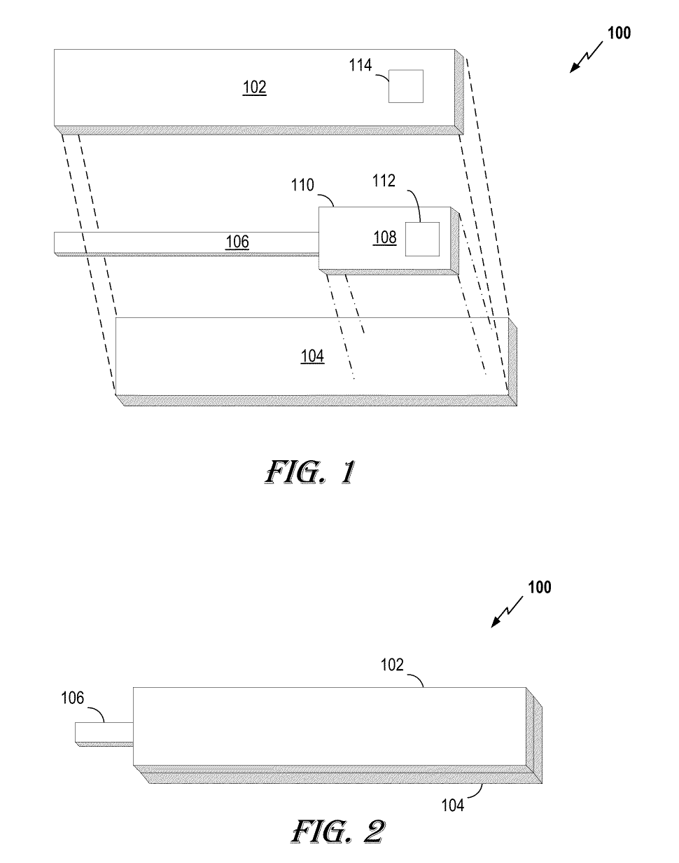

FIG. 1 illustrates a schematic of an exploded view for an example test reader.

The test reader 100 includes an upper housing 102, a lower housing 104, a test strip 106, and electronics 108 that may be at least partially and even more advantageously wholly placed in another housing 110. The upper housing 102 and the lower housing 104 may join to encapsulate all or part of the test strip 106 and electronics 108 with housing 110. It should be appreciated that upper and lower are used for convenience and clarity of description, and do not necessarily denote absolute orientations.

The test strip 106 may provide analyte detection based on a received sample. For example, the test strip 106 may detect the level of a hormone in urine to provide an indication of pregnancy. The test strip 106 may include various chemical properties to cause the analyte of interest to generate a detectable change on the test strip 106. For example, the analyte may bind to a certain material as the sample flows along the test strip 106. By detecting the quantity of material bound, a relative quantity of the analyte may be determined. As the material may have detectable properties (e.g., reflectance, magnetism, radioactivity, etc.), the presence and/or amount of the analyte may be derived from the detectable properties. Suitable test strips are well known, as described, for example, in U.S. Pat. No. 6,319,676. The test strip 106 may be removable from housing 110 in some embodiments such that the test strip 106 is provided and installed during or after assembly of the electronics 108 with housing 110 in the upper and lower housings 102 and 104 when assembling the complete reader kit 100 or when used by a consumer.

The electronics 108 may include various components to generate the test result. For example, the electronics 108 may include a printed circuit board. On the printed circuit board, one or more sensors such as a photosensor may be mounted. One or more light sources (e.g., LED) may be included in the electronics 108. For example, the light source may be configured to cast light on the test strip 106 and the photosensor may be configured to generate a signal indicating a property of the light reflected. The electronics 108 may include a processor configured to receive the signals and generate the test result. The test result may be generated as one or more signals for a display such as an LCD or LED 112 which may also be included in the electronics 108. The upper housing 102 may include an opening 114 for viewing the display from outside the outer enclosure formed by enclosure parts 102 and 104.

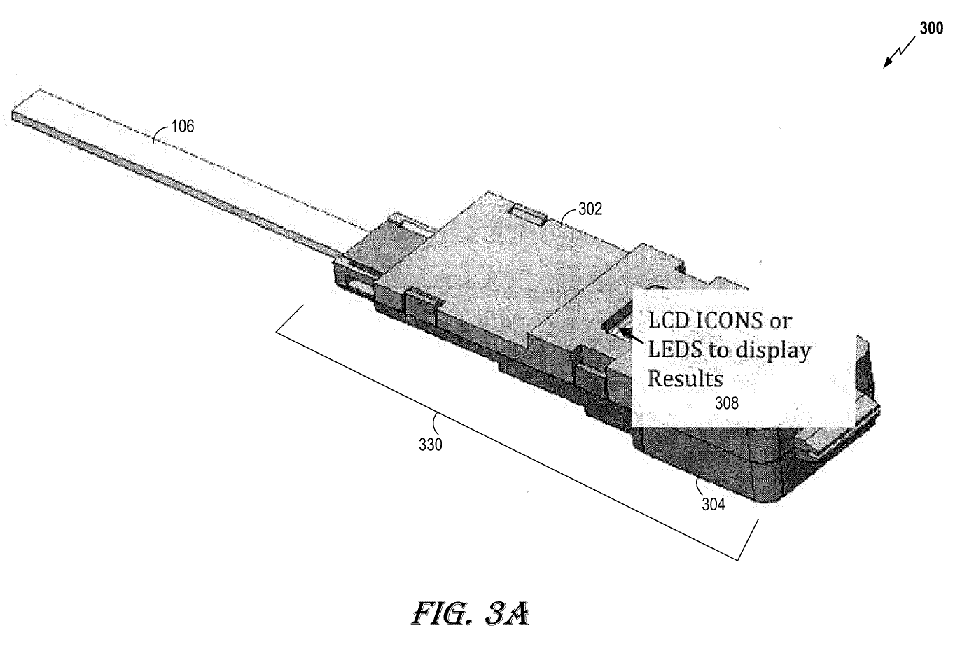

FIG. 2 illustrates a schematic of an assembled view for an example test reader. The test reader 100 is formed by the placement of the housing 110 containing the electronics 108 components between the upper housing 102 and lower housing 104. A portion of the test strip extends beyond the length of the housing to provide a surface for sample collection. In some implementations, the test reader 100 may include a cap which may surround the exposed portion of the test strip 106 and join the housing combination. This may be desirable, for example, to preserve the test strip and/or protect the test reader.

Typically, point of care or in-vitro diagnostic reader systems require design of customized integrated packages which require substantial design efforts. Most of the difficult design work requires encasing the electronics, integrating the test strip, and, when using photodetection techniques, providing light barriers. A configurable assembly including the electronics 108 in a dedicated housing 110 (and optionally also a test strip 106) and which may be included as a pre-designed and assembled package in various test readers eliminates the design work required for the integration of electronics 108. In some instances herein, the assembly of the electronics 108 and housing 110 (and optionally the strip 106 as well) is referred to as the engine of the test kit.

The engine provides simple product customization as it is a drop-in module into any product housing. This allows manufacturers to quickly change the housing without additional redesign of the engine. The engine may also provide ease of assembly. As the engine includes the necessary electronics, and in many cases the test strip as well, these sensitive parts may be provided in a single unit for inclusion in a test reader. Another non-limiting advantage is because the engine may be configured for use in a variety of test readers, the cost of the engine scales well to provide a low cost solution. The engine may only require minimal customization to the programmable circuits included in the electronics to be used for a variety of tests. For example, in a first configuration, the engine may be configured to detect light of a certain wavelength reflected from the test strip. In a second configuration, the engine may be configured to detect a time between two reflectance measurements within a given value. In such examples, the same physical engine assembly may be used with minimal updating to the function of the electronics to flexibly perform a variety of tests. In other examples, a variety of different electronic circuits 108 may be provided in housings 110 having an essentially identical outer size and configuration. This still allows drop in engines with different functionality to be used with a common outer housing 102/104, easily producing different test kits 100 where the only design constraint on the outer housing 102/104 is the ability to retain the engine. In some implementations, the engine may be included in test kits where it will be designed to operate within a pre-set number of tests.

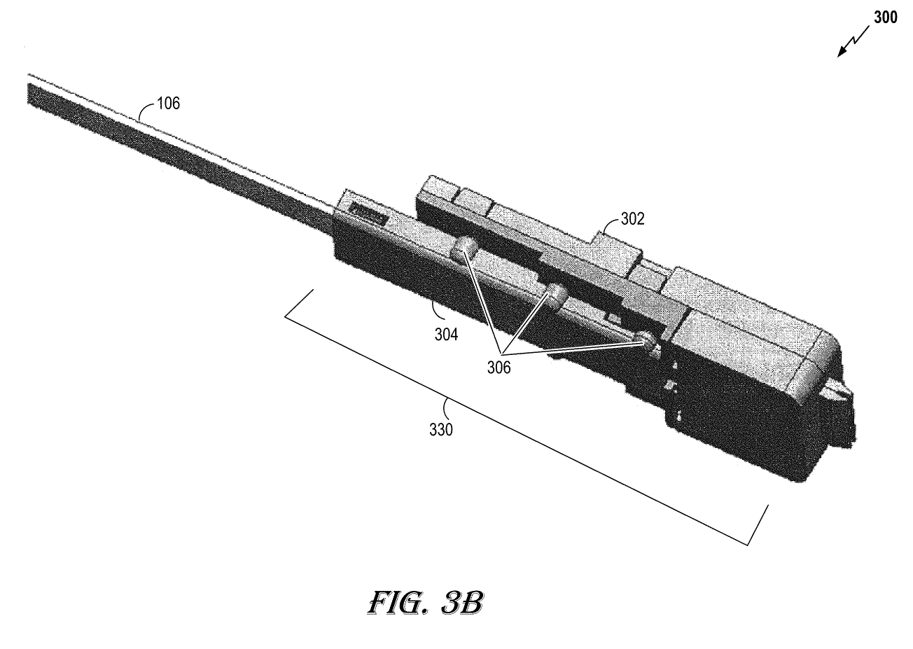

FIGS. 3A and 3B show schematic views of an exemplary test reader engine. The test reader engine 300 may be included in the test reader 100 described above. In this embodiment, the test reader engine 300 includes the test strip 106. The test strip 106 is coupled with an assembly 330.

The assembly includes an upper portion 302 and a lower portion 304 forming the housing 110 of FIGS. 1 and 2. The upper portion 302 may include a display 308 including visual indicators for providing test results, errors, timing information, or other visible indicators related to the test. The display 308 may include a liquid crystal display, icons, an LED, or other suitable means for rendering information. The lower portion 304 may include features for engaging the outer housing of the test kit (e.g. lower housing 104) such as press fit pins 306 that engage holes on the interior of the outer housing.

The test strip 106 is encased between the upper portion 302 and the lower portion 304. Accordingly, a portion of the test strip 106 extends into the assembly 330. The portion inside the assembly 330 is the portion that is monitored by the electronics for the test.

With this design, it is possible for all the electronics for the test reader to be provided in or on the inner housing 110, which is then positioned inside an outer housing. No electronics need be directly coupled to or provided on the outer housing. Also, the test strip need not be coupled directly to the outer housing. In advantageous embodiments, the only coupling between the electronics and the test strip with the outer housing is provided by the coupling between the outer housing and the inner housing.

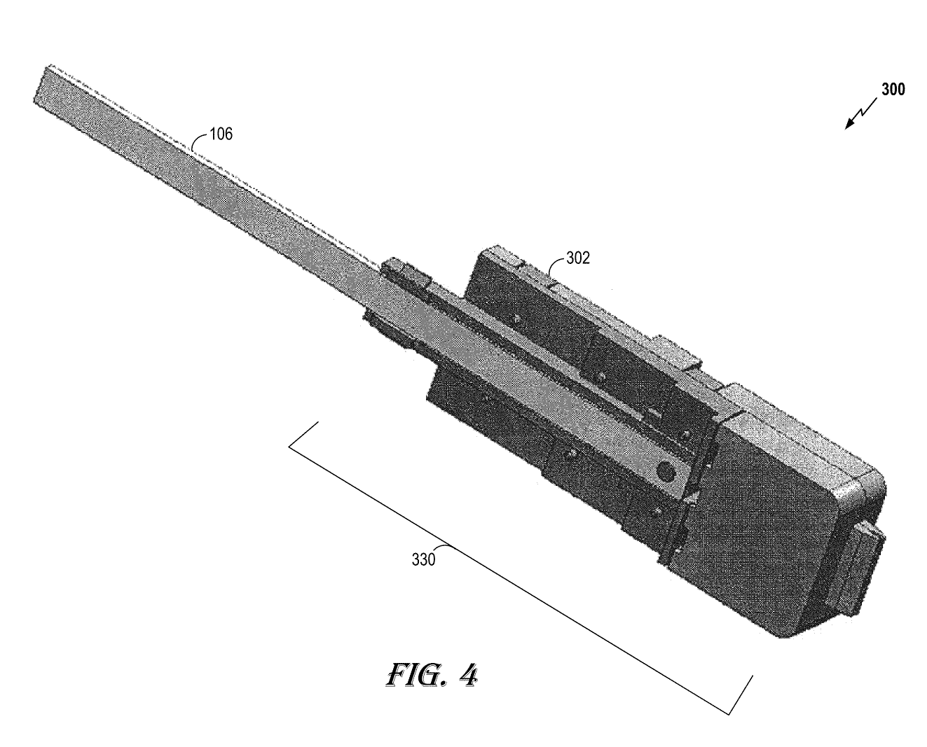

FIG. 4 shows a partially assembled view of an exemplary test reader engine with the lower housing removed. FIG. 4 illustrates the positioning of the test strip 106 within the assembly 330. The upper portion 302 may include the electronics, sensors, power, etc. for the test reader.

In some implementations, such as lab bench readers, the assembly 330 may not include the test strip 106. In such implementations, the strip or test device can be placed on the lab bench reader platform.

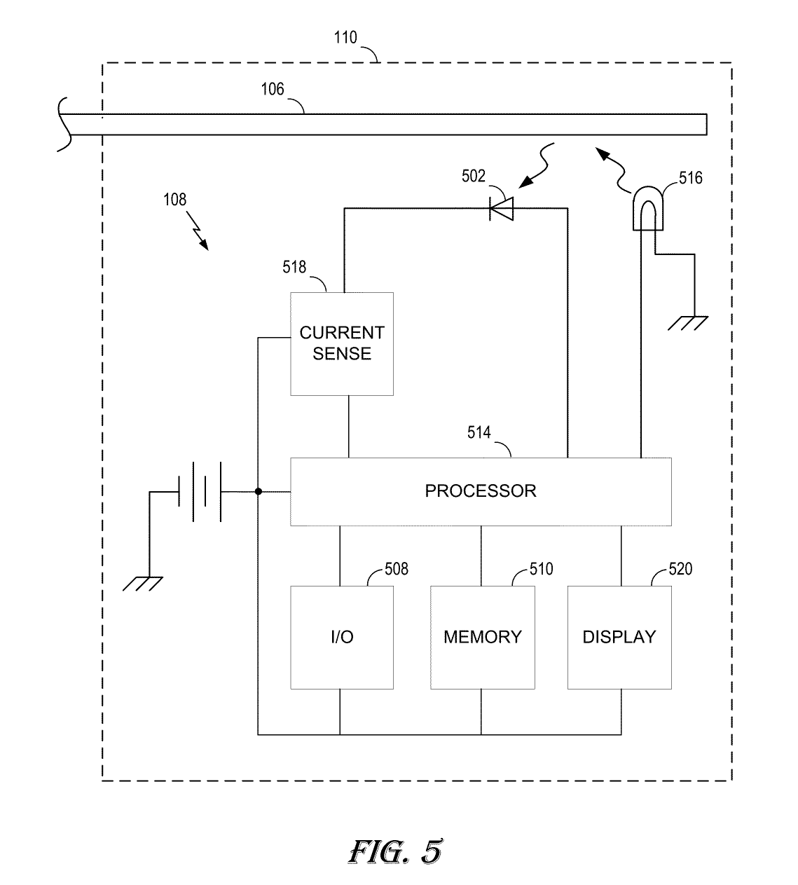

FIG. 5 illustrates a circuit diagram for an example electronics component of a test reader engine. The electronics may be formed on a printed circuit board or other suitable medium. The circuit diagram in FIG. 5 shows a simplified version of a circuit that may be used for photodetection tests. Accordingly, the electronics shown include one or more photodiodes 502. The photodiode 502 may be positioned such that light shields included in the upper portion 302 prevent extraneous light from reaching the photodiode 502.

The signal from the photodiode 502 may be provided to a current sensor 518 coupled to a processor 514 included in the electronics. The processor 514 may be configured to generate a test result based on one or more received signals from the photodiode 502. The processor 502 may be coupled with a memory 510. The memory 510 may store the configuration instructions for the test. These instructions may be read by the processor 502 to determine how a result is generated. The memory 510 may receive instructions via an input/output port 508. The input/output port may be a wired or wireless port configured to receive signals indicating tests to be performed. In some implementation, the signals may include a sequence of instructions to be performed by the processor. In some implementations, the signals may include preferences or variables indicating a pre-programmed test to perform.

The processor 514 may store information in the memory 510. For example, intermediate results, timing, counts, and the like may be stored in the memory 510. The information stored in the memory 510 may be transmitted via the input/output port 508.

The electronics may include a power source 512 such as a battery. The power source 512 may be coupled with the memory 510 and the processor 514. The electronics shown also include one or more LEDs or other light source 516. The light source 516 may be illuminated based on a signal from the processor 514. For example, the processor 514 may be configured, in some tests, to flash the light source 516 at known intervals while the photodiode 502 captures the reflection from the test strip for each flash. The received reflection intensity values may be used to generate the result, which may be output to a user on the display 520.

The specific arrangement shown in the electronics of FIG. 5 may vary for other engines. For example, magnetism may be used to analyze a test strip. In such an implementation, the photodiode 502 and lamp 516 may be replaced with a magnometer. Notwithstanding the specific sensing mechanism, the design of the electronics is such that the same physical layout of the housing 110 is maintained to be used in a variety of tests with negligible impact on its incorporation into an outer housing that forms the final test kit assembly.

Turning to another test reader embodiment (which may be used in conjunction with the physical test kit components described above), an improved accuracy test reader is provided. For ease of explanation, a photodetection test reader will be described. However, as discussed above, other sensors and detection schemes may be implemented without departing from the scope of the devices and methods described.

In some implementations, the test strip reader may include two photosensors, a front and a rear photosensor. Each photosensor may generate a signal indicating a luminance property of the test strip (e.g., reflectance). A processor may be configured to generate a test reading value based on a comparison between an initial photosensor reading and the current photosensor reading. Given a series of test reading values, fuzzy logic may be used to discriminate between the presence of a test line (e.g., positive test result), and the absence of a test line (e.g., negative test result).

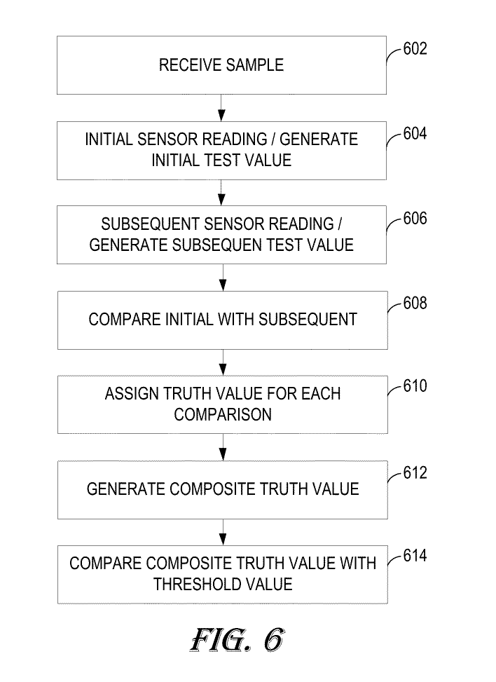

FIG. 6 illustrates a process flow diagram for generating a test result. The process shown in FIG. 6 may be implemented in one or more of the devices described above, such as that in FIG. 1, 2, or 5.

At block 602, a sample is received by the test reader. At block 604, an initial sensor reading is taken and a test value is generated. At block 606, a subsequent sensor reading is taken and a subsequent test value is generated. The generation of the test value and subsequent test value may include combining the corresponding sensor reading with one or more of a time, a coefficient, weighting factor, or the like.

At block 608, the subsequent test value is compared with the initial test value using the processor. The comparison may identify features of the test value such as the number of times the test value has risen or stayed the same as a previous value, the average rise (e.g., difference) between two test values, the final test value, and a maximum deviation from a moving average of test values. At block 610, each comparison is assigned a truth value according to its percentage membership in a fuzzy set using the processor. For example, if a test value of 0 represents a 0 percent membership, and a test value of 10 represents 100% membership, then a test value of 5 represents 50% membership. The comparisons may be repeated with the subsequent test value serving as the initial test value and a further test value provided as the subsequent test value. The comparison truth values may be stored in the memory.

Once the test values are obtained, at block 612, a composite truth value is generated based at least in part on the truth values for each comparison using the processor. The composite truth value may be generated as the product of the individual truth values for each comparison in the fuzzy set. The composite truth value may be generated by identifying the lowest or highest truth value of the individual truth values. The composite truth value may be stored in the memory for subsequent processing.

At block 614, the composite truth value is compared using the processor to a preconfigured threshold value. The preconfigured threshold value may be stored in memory associated with the processor. Based on the comparison of the composite truth value with the threshold value, a final test result is generated. For example, if the composite truth value is greater than the threshold, the final test result is positive. Otherwise, the final test result is negative. The final test result may be stored in the memory. In some implementations, the processor may be configured to generate a result signal to a display to present the result. For example, the display may include a green and a red LED. If the result is positive, the processor may transmit a signal to illuminate the green LED. Otherwise, the processor may transmit a signal to illuminate the red LED.

The process shown and described in reference to FIG. 6 may also be used to detect anomalies in the test. For example, the process may identify invalid test value patterns which may indicate an invalid test or a faulty test strip. In this way, additional confidence may be introduced in the final test value since the process may avoid providing false-negative or false-positive results where the test was not properly performed.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, a phrase referring to a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web-site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. Some implementations may include a non-transitory computer readable medium. For certain aspects, the computer program product may include packaging material.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc, or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the disclosure.

While the foregoing is directed to aspects of the present disclosure, other and further aspects of the disclosure may be devised without departing from the basic scope thereof.

What is claimed is:

1. A test reader comprising:
an inner housing containing a display, a sensor configured to generate a signal indicating a property of a test strip, and a processor configured to receive the signal from the sensor and generate a test result for presentation via the display based on the received signal; and
an outer housing having the inner housing contained therein.

2. The test reader of claim 1, further comprising a light source contained within the inner housing, wherein the sensor is a photodiode.

3. The test reader of claim 2, wherein the property of the test strip is an amount of light reflected by the test strip.

4. The test reader of claim 1, wherein the display is a liquid crystal display.

5. The test reader of claim 1, wherein the test strip is coupled to the inner housing.

6. A method of detecting an analyte in a sample on a test strip, the method comprising:
receiving a first plurality of values from a sensor indicating a property of the test strip;
generating a second plurality of values describing characteristics of the received values, each characteristic having a percentage membership value associated therewith;
generating a composite characteristic value based at least in part on the second plurality of values; and
generating a final test result based at least in part on a comparison between the composite characteristic value and a threshold.

7. A test strip reader comprising:
means for receiving a sample including an analyte of interest;
means for receiving a first plurality of values from a sensor indicating a property of the means for receiving the sample;
means for generating a second plurality of values describing characteristics of the received values, each characteristic having a percentage membership value associated therewith;
means for generating a composite characteristic value based at least in part on the second plurality of values; and
means for generating a final test result based at least in part on a comparison between the composite characteristic value and a threshold.

8. A computer-readable storage medium comprising instructions executable by a processor of an apparatus including a test strip, the instructions causing the apparatus to:
receive a first plurality of values from a sensor indicating a property of the test strip;
generate a second plurality of values describing characteristics of the received values, each characteristic having a percentage membership value associated therewith;
generate a composite characteristic value based at least in part on the second plurality of values; and
generating a final test result based at least in part on a comparison between the composite characteristic value and a threshold.

9. A test reader comprising an inner housing containing all the electronics for the test reader, wherein the inner housing is positioned inside an outer housing.

10. The test reader of claim 9, wherein a test strip is coupled to the inner housing.

11. The test reader of claim 10, wherein the test strip and all the electronics for the test reader are mounted to the outer housing only through an engagement between the inner housing and the outer housing.
